(19) United States
(12) Patent Application Publication
(10) Pub. No.: US 2008/0099956 A1
(43) Pub. Date: May 1, 2008

(54) FLAT MOLD FOR STONE PRODUCTS

(76) Inventor: Douglas H. Walden, Newark, OH (US)

Correspondence Address: OWENS CORNING, 2790 COLUMBUS ROAD, GRANVILLE, OH, 43023, US

(21) Appl. No.: 11/933,182

(22) Filed: Oct. 31, 2007

Related U.S. Application Data
(63) Continuation-in-part of application No. 11/319,675, filed on Dec. 28, 2005.

(51) Int. Cl. B28B 7/30

(52) U.S. Cl. 264/313; 249/55

(57) ABSTRACT

A mold for manufacturing stone products. The stone products have a major face, the major face has a texture that simulates the appearance of natural stone or brick, a back face opposed to the major face, a top face, a bottom face and a plurality of side faces, the stone product configured for installation with the major face in a vertical orientation. The mold comprises a flexible layer having a plurality of mold cavities. The mold cavities have a major wall configured to form the major face. The major wall have a texture configured for imprinting the desired texture on the major face, a back wall opposed to the major wall and configured to form the back face, a bottom wall configured to form the bottom face, and a plurality of side walls configured to form the side faces. The mold cavities are oriented such that the major wall is substantially vertical.

### RELATED APPLICATIONS

This application is a continuation-in-part of U.S. application Ser. No. 11/319,675 filed Dec. 28, 2005, the disclosure of which is incorporated in the present application in its entirety.

### TECHNICAL FIELD

This invention relates to simulated stone products. More particularly, this invention relates to a mold useful for manufacturing simulated stone products.

### BACKGROUND OF THE INVENTION

Simulated stone products include stone veneers and stone architectural trim products. Stone veneers are used as a lightweight veneer facing on masonry, and on metal framed or wood framed construction for architectural aesthetics. The products can be used for exterior applications such as building walls or interior applications such as fireplaces. Stone veneers can include simulated natural stones, such as granite, limestone, coral or river rock. Stone veneers can also include simulated new or used brick products. Stone architectural trim products include capstones, hearthstones, keystones, trim stones and the like. Simulated stone products are usually lower in cost than the natural stones that they replace.

CULTURED STONE® products are simulated stone products manufactured by Cultured Stone Corporation, a division of Owens Corning, Napa, Calif. The CULTURED STONE® product line includes hundreds of designs of precast stone veneers and architectural trim products that replicate an extensive variety of textures, sizes, shapes and colors of natural stone.

CULTURED BRICK® products are simulated brick products manufactured by Cultured Stone Corporation, a division of Owens Corning, Napa, Calif. The CULTURED BRICK® product line includes an extensive variety of designs of precast bricks that replicate an extensive variety of textures, sizes, shapes and colors of bricks.

Simulated stone products are manufactured using molds taken from natural stones or bricks. The molds generally include a mold cavity that is filled with a castable material. After the castable material has cured, or set, the flexible layer is stretched or distorted to remove the stone products from the mold.

It would be advantageous if the molds for stone products could be improved to make them more efficient.

### SUMMARY OF THE INVENTION

The above objects as well as other objects not specifically enumerated are achieved by a mold for manufacturing stone products. The stone products have a major face, the major face has a texture that simulates the appearance of natural stone or brick, a back face opposed to the major face, a top face, a bottom face and a plurality of side faces, the stone product configured for installation with the major face in a vertical orientation. The mold comprises a flexible layer having a plurality of mold cavities. The mold cavities have a major wall configured to form the major face. The major wall have a texture configured for imprinting the desired texture on the major face, a back wall opposed to the major wall and configured to form the back face, a bottom wall configured to form the bottom face, and a plurality of side walls configured to form the side faces. The mold cavities are oriented such that the major wall is substantially vertical.

According to this invention there is also provided a method of manufacturing stone products. The stone products have a major face, the major face has a texture that simulates the appearance of natural stone or brick, a back face opposed to the major face, a top face, a bottom face and a plurality of side faces. The method comprising providing a mold, the mold has a flexible layer, the flexible layer has a plurality of mold cavities, each mold cavities has a major wall configured to form the major face, the major wall has a texture configured for imprinting the desired texture on the major face, a back wall opposed to the major wall and configured to form the back face, a bottom wall configured to form the bottom face and a plurality of side walls configured to form the side faces, the mold cavities are oriented such that the major wall is substantially vertical, introducing a castable material into the mold cavities, allowing the castable material to harden to form the stone products, and removing the stone products from the mold cavities.

Various advantages of this invention will become apparent to those skilled in the art from the following detailed description of the preferred embodiments, when read in light of the accompanying drawings.

### BRIEF DESCRIPTION OF THE DRAWINGS

FIG. 1 is a perspective view of a stone product.

FIG. 2 is a partial side view, in cross section, of a mold apparatus.

FIG. 3 is a perspective view, partially in phantom, showing a partial flexible layer having mold cavities.

FIG. 4 is a perspective view, partially in phantom and partially in cross-section, of a production mold.

FIG. 5 is a perspective view, partially in phantom, of installed stone product.

FIG. 6 is a perspective view of an imprint member configured to apply texture to a face of the stone product.

FIG. 7 is a perspective view of multiple stones stacked together in a master mold (shown in phantom).

### DETAILED DESCRIPTION OF THE INVENTION

Simulated stone veneer products can be in the form of relatively flat-shaped pieces, such as for example granite veneers, limestone veneers, river rock veneers or new or used bricks. Flat-shaped stone products are manufactured using molds taken from natural stones or bricks. The molds generally include a mold cavity that is filled with a castable material. After the castable material has cured, or set, the flexible layer is flexed, stretched or distorted to remove the simulated stone products from the mold. As used herein, the term natural stone is defined to include natural stone and brick.

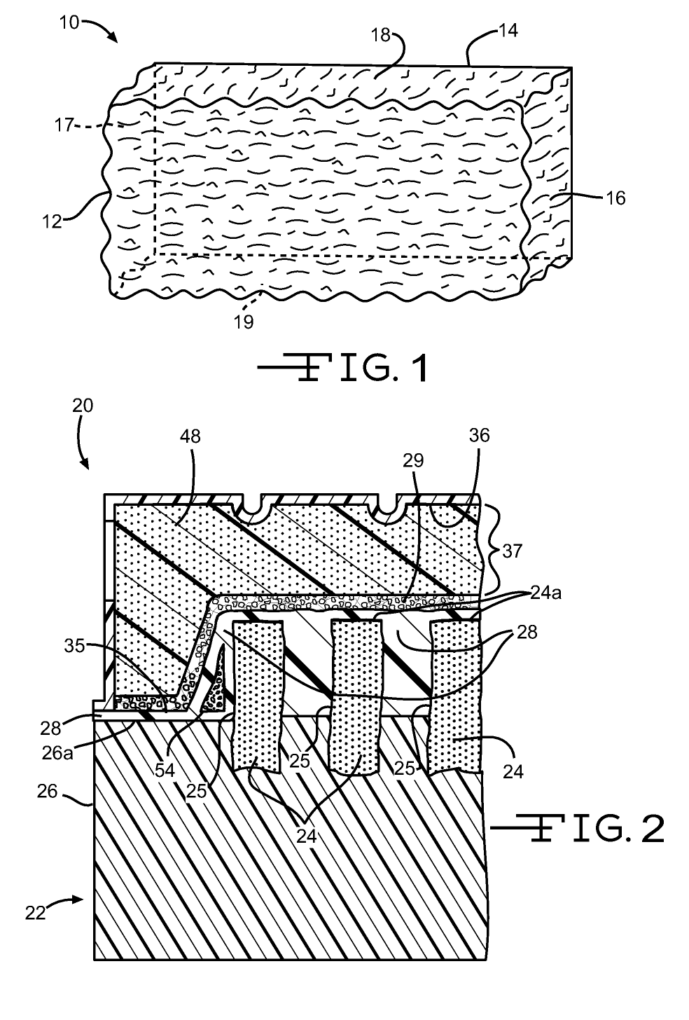

As shown in FIG. 1, a flat-shaped stone product 10 includes a major face 12 and a back face 14 opposed to the major face 12. As further shown in FIG. 1, the major face 12 can be textured to simulate the appearance of natural stone. In this embodiment, the back face 14 of the stone product 10 has a non-textured surface. Alternatively, the back face 14 can have any other texture, such as a scratch coat, conducive for application to a structural surface. The stone product 10 has opposing side faces 16 and 17. In one embodiment, the opposing side faces 16 and 17 can be textured to simulate the appearance of natural stone. The stone product 10 also includes a top face 18 and a bottom face 19. In this embodiment as shown in FIG. 1, the bottom face 19 is textured to simulate the appearance of natural stone and the top face 18 has a non-textured surface.

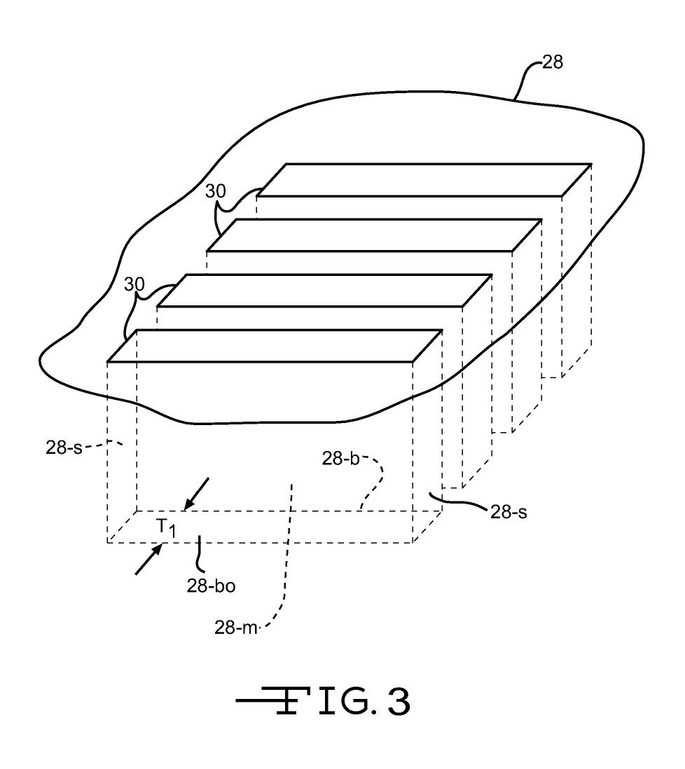

Stone products 10 are manufactured using molds taken from natural stones. The procedure for making the molds themselves is shown in FIG. 2. As shown in FIG. 2, the molds are produced by a mold apparatus 20. The mold apparatus 20 includes a master mold 22 which is produced by setting flat-shaped natural stones 24 in a base 26. Real natural stones 24 are used to make the mold, and then the mold is used to mold the stone products 10. While FIG. 2 illustrates the use of flat-shaped natural stones 24, it is to be appreciated that flat-shaped bricks could also be used. The flat-shaped natural stones 24 have a major stone face 25. The flat-shaped natural stones 24 are selected based on the size and shape of the stone, and the lack of defects and the presence of aesthetically pleasing material surface features on the major stone face 25. The natural stones 24 are arranged on the base 26 so that the major stone faces 25 are oriented in a substantially vertical plane and the stones 24 protrude from a top surface 26a of the base 26. In one embodiment, the stones 24 are positioned in a parallel arrangement as shown in FIG. 2. In another embodiment, the stones 24 can be positioned in another arrangement. In this embodiment, the stones 24 are positioned on the base 26 such that the bottom face of the stone 24 is placed on the base 26. In another embodiment, the stones 24 can be positioned on the base such that the one of the opposing side faces 16 or 17 is placed on the base 26. While the mold apparatus 20 illustrated in FIG. 2 includes three stones 24, it is to be appreciated that the mold apparatus 20 can have any number of stones 24.

Generally, the master mold 22 is made by pouring a curable urethane resin or similar curable base 26 around the natural stones 24, and allowing the urethane to cure to set the stones 24 in the base 26.

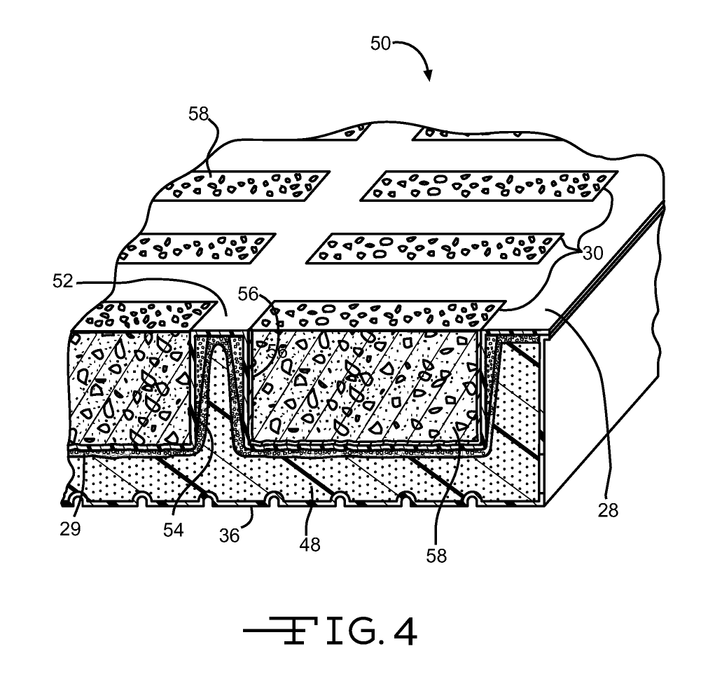

After the base 26 has set and the stones 24 are substantially fixed in the base 26, at least one flexible layer 28 is applied over an exposed surface 24a of the stones 24 and an exposed surface 26a of the base 26 to form a mold cavity 30 as shown in FIG. 3. The flexible layer 28 conforms to the shape of the exposed surface 24a of the stones 24 and the exposed surface 26a of the base 26. It can be seen that the flexible layer 28 in FIG. 2 becomes flexible layer 28 shown in FIG. 3.

In one embodiment, the flexible layer 28 can be made from one or more layers of a suitable flexible material and can be applied by any suitable method. The flexible layer 28 conforms its shape around the exposed surface 24a of the natural stones 14 and the exposed surface 26a of the base and retains that shape when the flexible layer 28 is removed from the master mold 22 and is in use. The flexible layer 28 can be made from one or more layers of a suitable flexible material, such as a curable elastomeric, latex or silicone rubber, or any other material suitable to form the mold cavities 30 and to flex when the simulated corner stone products 10 are removed from the mold cavities 30. In another embodiment, the master mold 22 includes positioning the natural stones 24 on a pedestal (not shown). The flexible layer 28 is subsequently formed in a similar manner. An example of a master mold formed using a pedestal is a master mold technique of the type disclosed in U.S. patent application Ser. No. 11/319,675 filed Dec. 28, 2005, which is hereby incorporated by reference, in its entirety.

Referring again to FIG. 2, in certain embodiments a mold support 36 is used in the mold-making process so that the flexible layer 28 will have a rigid support structure after the flexible layer 28 is molded. The mold support 36 can include a backing layer 29 which substantially covers a back surface 35 of the flexible layer 28. The backing layer 29 is applied such that the backing layer 29 also somewhat conforms to the shape of the exposed surface 24a of the stones 24, closely following their contours. The backing layer 29 is configured to support the flexible layer 28. In this embodiment, the backing layer 29 comprises a porous material such as, for example, a breathable mesh material. In another embodiment, the backing layer 29 can be a polyurethane-fiberglass applied non-woven mat material or any other material sufficient to support the flexible layer 28.

The mold support 36 is positioned over the flexible layer 28; or, if the backing layer 29 is present, over the backing layer 29. A gap or space 37 remains between the mold support 36 and the flexible layer 28, or the backing layer 29, when the backing layer 29 is present. In the illustrated embodiments, a structural material 48 fills the gap 37 between the mold support 36 and the backing layer 29. The material 48, when hardened, provides support to the flexible layer 28. The material 48 can be introduced by any suitable means. In the illustrated embodiment, the material 48 is a load supporting material capable of providing structural strength. The material 48 can be any type of material such as, for example, foams such as polyurethane, polystyrene and polyphenylene oxide, or any other type of material sufficient to be a load supporting material capable of providing structural support to the flexible layer 28.

Referring to FIG. 3, after the structural material 48 has cured, the master mold 22 including the natural stones 24 is removed, thus providing a flexible layer 28. The flexible layer 28 retains its shape after removal of the master mold 22. The flexible layer 28 includes mold cavities 30 corresponding to the natural stones 24. Each mold cavity 30 has a formed wall corresponding to a face of the natural stone 24. Each mold cavity 30 includes a major wall 28-m, a back wall 28-b, bottom wall 28-bo, and side walls 28-s. The side walls 28-s extend between the major wall 28-m and the back wall 28-b. In one embodiment, the major wall 28-m, the bottom wall 28-b, and the side walls 28-s are configured for imprinting a texture that simulates the appearance of natural stone on the major face 12, the bottom face 19 and the side faces 16 and 17, respectively. In another embodiment, the major wall 28-m is configured for imprinting a texture that simulates the appearance of natural stone on the major face 12 and the remaining walls 28-b, 28-bo and 28-s of the mold cavity 30 are configured to form non-stone texture faces on the stone product 10.

In another embodiment, the back wall 28-b of the mold cavity 30 is configured for imprinting a scratch coat on the back face 14 of the stone product 10. A scratch coat is a grooved or rough pattern that assists the installer in applying the stone product 10 to a structural surface. Specifically, the rough pattern of the scratch coat on the back face 14 of the stone product 10 provides an efficient surface for the installation mortar to adhere to. The scratch coat can be any pattern, such as cross-hatch, circular or irregular sufficient to provide a grooved or rough pattern.

In certain embodiments as further shown in FIG. 4, the flexible layer 28 also has support sections 52. The support sections 52 are defined by the areas surrounding the major wall 28-m, the back wall 28-b and the side walls 18-s. In the embodiment shown in FIG. 4, the support sections 52 generally have a flexural modulus that is stiffer or more rigid than the flexural modulus of the major wall 28-m, the bottom wall 28-b, and the side walls 28-s.

In certain embodiments, as shown in FIG. 3, the stone product can have a thickness T1. In certain embodiments, the thickness T1 can be in a range from about 0.125 inches to about 1 inch. In another embodiment, the thickness T1 can be less than 0.125 inches or more than 1 inch.

Also, in certain embodiments as shown in FIGS. 2 and 4, the flexible layer 28 has a reinforcing material 54 added to, or within, the side walls 28-s. The reinforcing material 54 reinforces the side walls 28-s, yet allows the side walls 28-s to still retain the desired flexibility for removal of molded stone products 10 after molding. In certain embodiments, the reinforcing material 54 can be a paste-like material comprising, for example, a latex material, ground up rubber tire, sawdust, and MgO composition. Also, other suitable materials can be used.

As further shown in FIG. 4, the flexible layer 28 is incorporated into a production mold 50. The production mold 50 also includes the backing layer 29, the structural material 48 and the mold support 36.

As illustrated in FIG. 4, the production mold 50 includes a plurality of mold cavities 30. In this embodiment, the mold cavities 30 are oriented such that the major wall 28-m of the mold cavity 30 is substantially vertical. The substantially vertical orientation of the mold cavity 30 results in more mold cavities 30 for every production mold 50. More mold cavities 30 for every production mold 50 results in more stone product 10 for every production mold 50 casting, which is a primary factor in reducing the manufacturing cost of the stone product 10.

Referring again to FIG. 4, the mold cavities 30 filled with castable material 58 are schematically illustrated. In certain embodiments, at least portions of each mold cavity 30 are painted with one or more layers 56 of suitable stone-colored paints. In certain embodiments, especially where the flexible layer 28 has deep and/or narrow side walls 28-s, the painting can be done by flexing or stretching the flexible layer 28 to expose the interior of the mold cavity 30.

A castable material 58 is introduced into the mold cavities 30. The castable material 58 can be introduced by any suitable means, such as by pouring the castable material 58 into the mold cavities 30. In certain embodiments, the flexible layer 28 may be vibrated after the castable material 58 substantially fills the mold cavities 30 to insure that the castable material 58 flows into all the contours of each mold cavity 30.

It is to be understood that any suitable castable material 58 can be used for producing the stone products 10. In one embodiment, the castable material 58 is a lightweight concrete material comprising Portland cement, lightweight aggregates and mineral oxides. However, other castable materials 58 are also useful, such as plaster of Paris or a ceramic material.

Upon hardening, the castable material 58 in each of the mold cavities 30 becomes a stone product 10, as shown in FIG. 1. After hardening, the stone product 10 is then removed from the mold cavities 30 in a suitable manner.

In certain embodiments, the stone product 10 is at least partially dislodged from the mold cavity 30 by flexing or stretching the flexible layer 28 to force the stone product 10 from its mold cavity 30. In certain embodiments, a pressurized fluid, such as air, is introduced between the flexible layer 28 and the mold support 36. In embodiments where the flexible layer 28 includes support sections 52, the support sections 52 of the flexible layer 28 are at least partially restrained from being stretched or distorted by the pressurized fluid. The major wall 28-m, the back wall 28-b, the bottom wall 28-bo, and the side walls 28-s are stretched or flexed, thereby lifting the stone product 10 from its mold cavity 30. In embodiments where the porous backing layer 29 is present, the pressurized fluid passes through the porous backing layer 29 to the flexible layer 28.

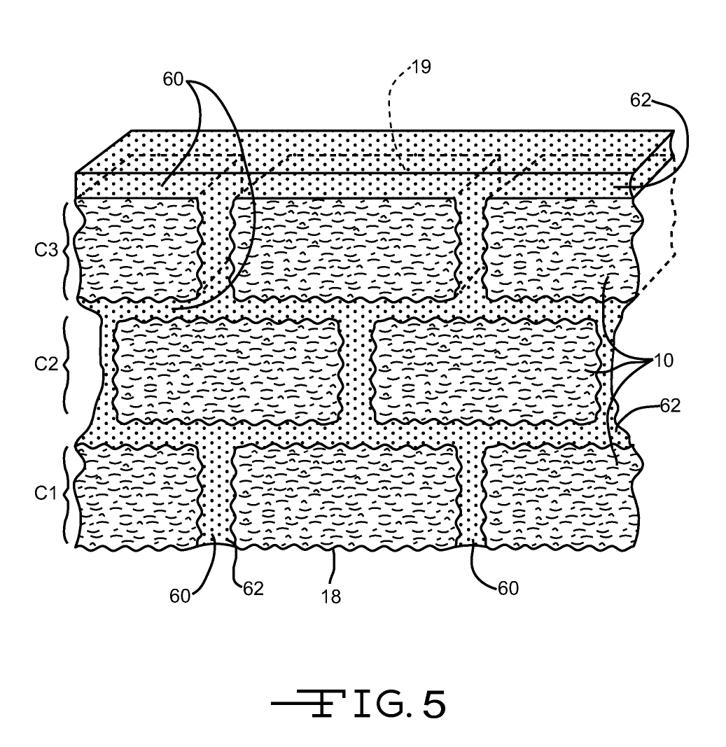

In one embodiment as shown in FIG. 5, the stone product 10 can be installed on masonry and on metal framed or wood framed construction. The stone product 10 can be installed in any desired arrangement or pattern. A first course C1 of stone product 10 is attached to the masonry or framed construction using any suitable adhesive material. In one embodiment, the stone product 10 is adhered to the masonry or framed construction such that the major face 12 is exposed and the top face 18 faces downward. Additional courses, C2 and C3, are applied in a similar fashion. The applied courses C1, C2 and C3 define spaces 60 between the stone products 10. In this embodiment, the spaces 60 are filled with a filler material 62. The filler material 62 is configured to seal the spaces 60 between the stone products 10. The filler material 62 can be any material, such as mortar or grout, sufficient to seal the spaces 60 between the stone products 10. As additional courses are installed and the spaces 60 are filled with the filler material 62, the non-textured top face 18 is hidden from view by the downward orientation and the installed filler material 62. In another embodiment, the stone products 10 can be installed with the non-textured top faces 18 facing upward. In a similar manner, a filler material 62 seals the spaces 60 between the stone products 10. In this embodiment, the non-textured top face 18 is hidden from view by the upward orientation and the installed filler material 62. In yet another embodiment, the stone products 10 can be installed with the textured major face 12 exposed and any number of faces 14, 16, 17, 18 19 being textured or non-textured.

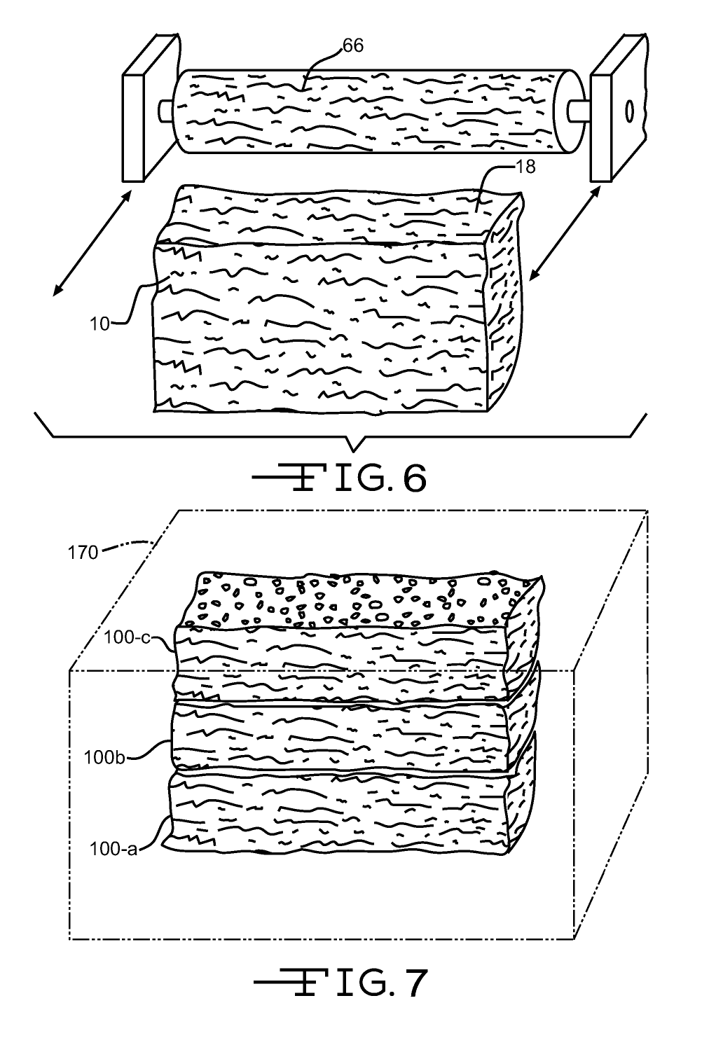

In certain embodiments, for example when the top face 18 may be visible upon close inspection, a textured, or simulated, stone appearance may be desired for the top face 18 of the stone product 10. The textured stone appearance may be imprinted on the top face 18 of the stone product in several manners. In one embodiment, a textured surface can be formed on the top face 18 by an imprint member 66 as shown in FIG. 6. The imprint member 66 is used on the castable material 58 before it is set to provide an additional stone-like appearance to the top face 18. The imprint member 66 is mounted for rotation on the castable material 58. The imprint member 66 can be made of any suitable material, such as a urethane, latex or silicone rubber material. The texture of the imprint mold can be cast from natural stone. In other embodiments, the textured stone appearance is accomplished by positioning a patterned element (not shown) over the castable material 58 during the vibration step of the molding process. As the castable material 58 is vibrated, the patterned element imprints the textured stone appearance on the top face 18 of the castable material 58. In this embodiment, the patterned element can be an elastomeric, or rubber-like, material or can be a plastic sheet temporarily laid against the top face 18.

In yet another embodiment, the aesthetics of the stone products 10 can be further enhanced by a post-screeding painting step. The post-screeding painting step includes applying paint to the top face 18 of the stone product 10 after the flexible layer 28 has been filled and screed, but before any settling or vibrating step. The paint provides a generally uniform color to the top face 18, and the subsequent vibration step blends the paint into the castable material 58. In certain embodiments, the post-screeding paints can be low-viscosity paints which are readily dispersed into the top face 18. Alternatively, the paint can be applied to the untextured top face 18 after the vibration step. In such embodiments, the paint can be high viscosity paint which smoothes the top face 18 and reduces the visual awareness of the aggregates.

In still another embodiment, an excess amount of paint 56 is applied to one or more of the major wall 18-m, the bottom wall 18-bo, or the side walls 18-s, before the mold cavity 20 is filled with the castable material 58. The extra amount of paint 56 within the mold cavity 20 causes a supply of paint 56 to remain, or puddle, in the bottom of the mold cavity 20. When the mold cavity 20 is filled with the castable material 58 and then vibrated, the paint 56 migrates along the major wall 18-m, the bottom wall 18-bo, and the side walls 18-s of the mold cavity 20. The paint 56 flows, or oozes, onto at least an outer perimeter (i.e., the outer areas of the surface) of the top face 18 of the stone product 10, creating a painted top face. Since the perimeter of the top face 18 is one of the points of visual contact on the installed wall of stone product 10, there is an aesthetically pleasing appearance to the stone product 10.

Referring now to FIG. 7, another embodiment is shown. A mold 170 comprises a pre-mortared, or drystack, set of two or more adjacently positioned stones, shown as 100-a, 100-b, 100-c. When the drystack stone products are made, the drystack (made of multiple stones) is demolded as one piece. The stones are cast in an adjacent position such that a stone product has the look of a stack of stones. In using this multiple stacked stone production mold 170, the throughput is greatly increased. While the drystack in FIG. 7 illustrates stacked stones, in another embodiment, the stones can be molded to be horizontally adjacent to each other.

The principle and mode of operation of the flat mold have been described in various embodiments. However, it should be understood by those skilled in the art that the flat mold may be practiced otherwise than as specifically illustrated and described without departing from its essential scope.

What is claimed is:

1. A mold for manufacturing stone products, the stone products having a major face, the major face having a texture that simulates the appearance of natural stone or brick, a back face opposed to the major face, a top face, a bottom face and a plurality of side faces, the stone product being configured for installation with the major face in a vertical orientation, the mold comprising:
a flexible layer having a plurality of mold cavities, the mold cavities having:
a major wall configured to form the major face, the major wall having a texture configured for imprinting the desired texture on the major face;
a back wall opposed to the major wall and configured to form the back face;
a bottom wall configured to form the bottom face; and
a plurality of side walls configured to form the side faces;
wherein the mold cavities are oriented such that the major wall is substantially vertical.

2. The mold of claim 1 in which the mold cavities are oriented such that the wall of the mold corresponding to the bottom face of the stone product is substantially vertical.

3. The mold of claim 1 in which the major wall of the mold and the back wall of the mold have substantially different planar orientation.

4. The mold of claim 1 in which the wall of the mold corresponding to the bottom face of the stone product is configured for imprinting the desired texture on the bottom face.

5. The mold of claim 1 in which the walls of the mold corresponding to the side faces of the stone product are configured for imprinting the desired texture on the side faces.

6. The mold of claim 1 in which the mold cavities are configured to form stone products having the appearance of two or more adjacently positioned stones.

7. The mold of claim 1 in which the stone products are configured to have the appearance of being stacked.

8. The mold of claim 1 in which the wall of the mold corresponding to the back face of the stone product is configured for forming a scratch coat on the back face.

9. A method of manufacturing stone products, the stone products having a major face, the major face having a texture that simulates the appearance of natural stone or brick, a back face opposed to the major face, a top face, a bottom face and a plurality of side faces, the method comprising:
providing a mold, the mold having a flexible layer, the flexible layer having a plurality of mold cavities, the mold cavities having a major wall configured to form the major face, the major wall having a texture configured for imprinting the desired texture on the major face, a back wall opposed to the major wall and configured to form the back face, a bottom wall configured to form the bottom face and a plurality of side walls configured to form the side faces, wherein the mold cavities are oriented such that the major wall is substantially vertical;
introducing a castable material into the mold cavities;
allowing the castable material to harden to form the stone products; and
removing the stone products from the mold cavities.

10. The method of claim 9 in which the mold cavities are oriented such that the wall of the mold corresponding to the bottom face of the stone product is substantially vertical.

11. The method of claim 9 in which the major wall of the mold and the back wall of the mold have substantially different planar orientation.

12. The method of claim 9 in which the wall of the mold corresponding to the bottom face of the stone product is configured for imprinting the desired texture on the bottom face.

13. The method of claim 9 in which the side walls of the mold corresponding to the side faces of the stone product are configured for imprinting the desired texture on the side faces.

14. The method of claim 9 in which the mold cavities are configured to form stone products having the appearance of two or more adjacently positioned stones.

15. The method of claim 9 in which the stone products have the appearance of being stacked.

16. The method of claim 9 in which the wall of the mold corresponding to the back face of the stone product is configured for forming a scratch coat on the back face
